(19) United States
(12) Patent Application Publication
(10) Pub. No.: US 2007/0266691 A1
(43) Pub. Date: Nov. 22, 2007

(54) Blade shoe

(76) Inventors: Michael R. Elliott, Hendersonville, TN (US); Felix M. Cook, Halls, TN (US)

Correspondence Address: Felix M. Cook, 2143 Double Bridge-Unionville Road, Halls, TN, 38040, US

(21) Appl. No.: 11/194,329

(22) Filed: Aug. 1, 2005

(51) Int. Cl. A01D 67/00

(52) U.S. Cl. 56/320.1

(57) ABSTRACT

A tubular device (1) constructed of a material strong enough to withstand the torque of a typical air wrench or cheater bar used by a lawn mower repair shop or a homeowner. One end of the device (1) must have an opening (4) and be of the size as to allow a lawn mower blade (5) to be inserted inside of it. On this end is located a leveler and/or retainer (10) to raise the opposite end of the device to assure it remains at or above the horizontal plane of the mower blade (5) allowing it to provide a safer prop against the discharge or underside of a mower deck (6). This device may include a pin or shaft (2) to act as a stop for the device sliding over or upon the blade (5) to provide economics for manufacturing, (one size fits all). This adjuster for the blade may also act as a fastener for an additional tubing to be added (7) to the device (1) to allow it to function with extremely long blades (5). In addition, a shorter version of the tubular device can be obtained by the addition of a non-tubular extension (11). The opposite end of the tube opening (4) is best suited for a non-metallic material coating or addition (8) to act as an inhibitor for sparks and splinters.

### BACKBROUND—FIELD OF INVENTION

This invention relates to the removal and installation of lawn mower blades, specifically to produce devices to be placed upon or over lawn mower blades to assist in stopping rotation of said blades so they may be safely removed and or installed.

### BACKGROUND—DESCRIPTION OF PRIOR ARTS

Searches at the patent library revealed that no apparent patented prior arts exist. The only device to assist homeowners or novices in this procedure that lawn mower manufacturers and their service technicians recommend is a block of wood wedged between the mower housing and the blade. Far too many times this practice results in injury for the novice because the block tends to fall and allows the blade to rotate. The results are usually skinned knuckles, cut hands or fingers, or the complete lose of the same.

Also technicians, while performing this process in factory trained shops, commonly use an air wrench to loosen or tighten the blade retaining bolts with one hand while holding the blade with the other. The primary protection for the hands is a rag over the blade or wearing a glove on the hand that holds the blade. This procedure has often resulted in injury to the technician because it depends on their strength and balance to hold the blade steady while using torque of said air wrench. Often, the retaining bolt is frozen or the technician over tightens said retainer and cannot hold the blade. This injury is usually more severe than the novice because of the strength and speed of said air tool.

### OBJECTS AND ADVANTAGES

Accordingly, the need for a device to safely stop the rotation of a rotary mower blade during removal and installation has existed since the rotary mower was invented. Several advantages of this invention are as follows:

(a) to provide devices that allow a significantly safer procedure than the current available devices for the removal and installation of rotary mower blades;

(b) to provide devices for said procedure that novices can easily use;

(c) to provide devices that are fast enough for said procedures that professionals will use them;

(d) to provide devices that are adjustable to accommodate multiple blade widths and lengths;

(e) to provide devices for said procedure that are inexpensive to manufacture;

(f) to provide devices that secure mower blades in a manner that the manufacture's torque specification on the retainer bolt may be accurately obtained;

Further objects and advantages are to provide a device that may also be commercially coated to prevent damage to the lawn mower deck and provide an insulator which would serve as a spark arrester in case fuel has been spilled at or about said deck. Still further objects and advantages will become apparent from the drawings and descriptions.

### SUMMARY

The invention is based on a particular device for the use of removal and installation of lawn mower blades. The device is designed to slide over or upon a lawn mower blade acting as an extension of said blade for a predetermined distance. This allows the device to pass through the discharge or the underside of a mower deck, thus restricting the rotation of said blade when torque is applied to remove or install the blade

In the drawings, corresponding numbers represent the same item or closely related items

DRAWING FIGURES

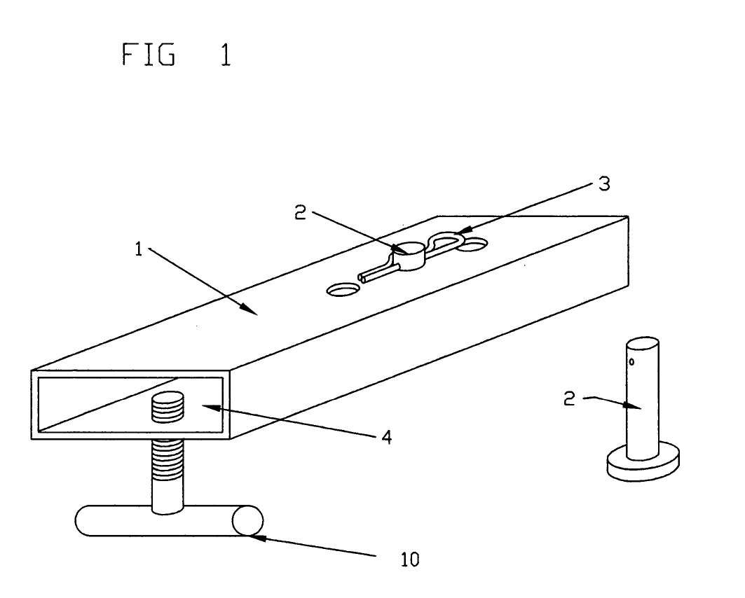

FIG. 1 shows the right-hand elevated view of a blade shoe of which 1 shows this particular shape is of rectangular construction in length and depth, 4 showing it is hollow, 2 being the adjuster for depth, 3 being the adjuster retaining pin, 5 being the leveling and/or blade retainer.

FIG. 2 shows a blade shoe 1 on the outer blade of a multi-blade mower deck 6, restricting the rotation of the blade 5, for removal or installation of blade retainer 6.

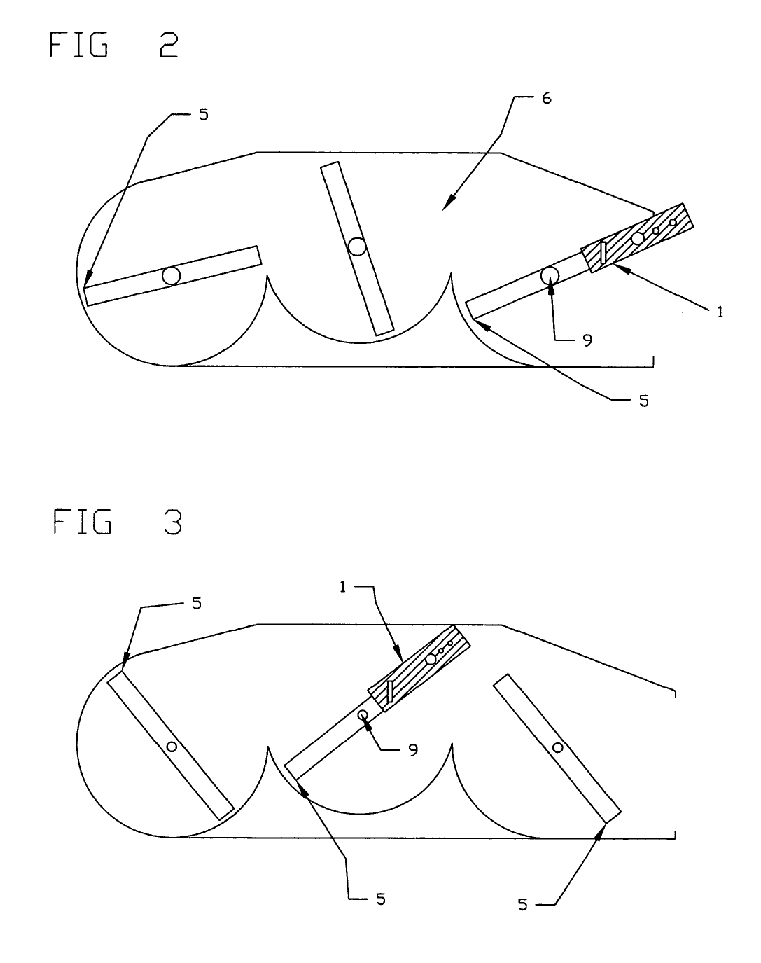

FIG. 3 shows a blade shoe 1 on the middle blade 5 of a multi-blade mower deck 6, thus stopping its rotation when retainer 9 is loosened or tightened.

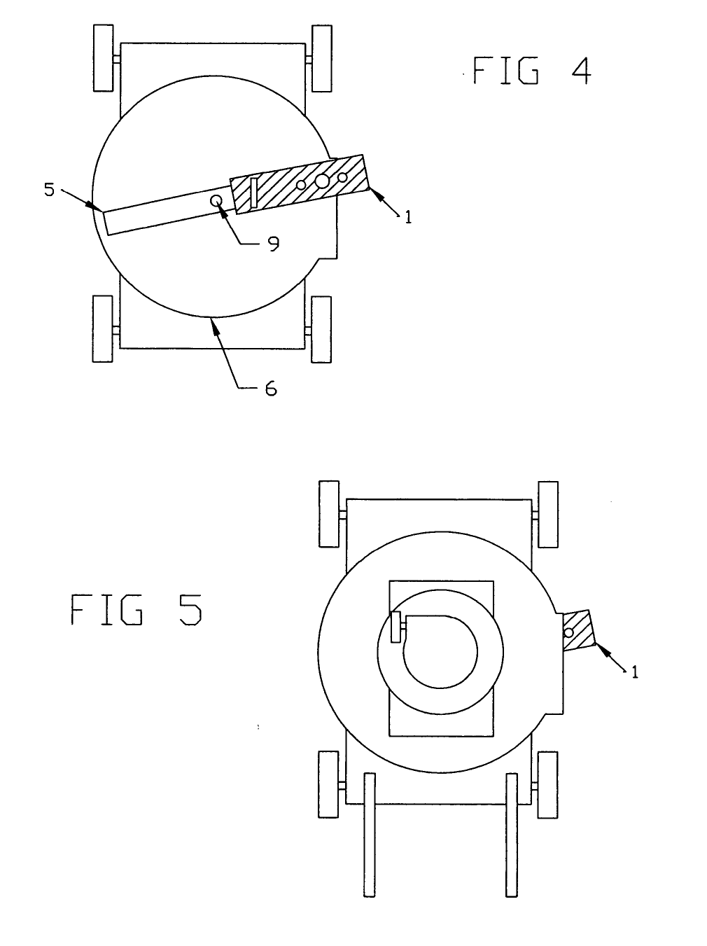

FIG. 4 shows a blade shoe 1 on the blade 5 of a push mower deck 6 when retainer 9 is loosened or tightened.

FIG. 5 shows the top view of a single-blade lawn mower with blade shoe 1 on blade 5 extending through the outlet of lawn mower deck 6.

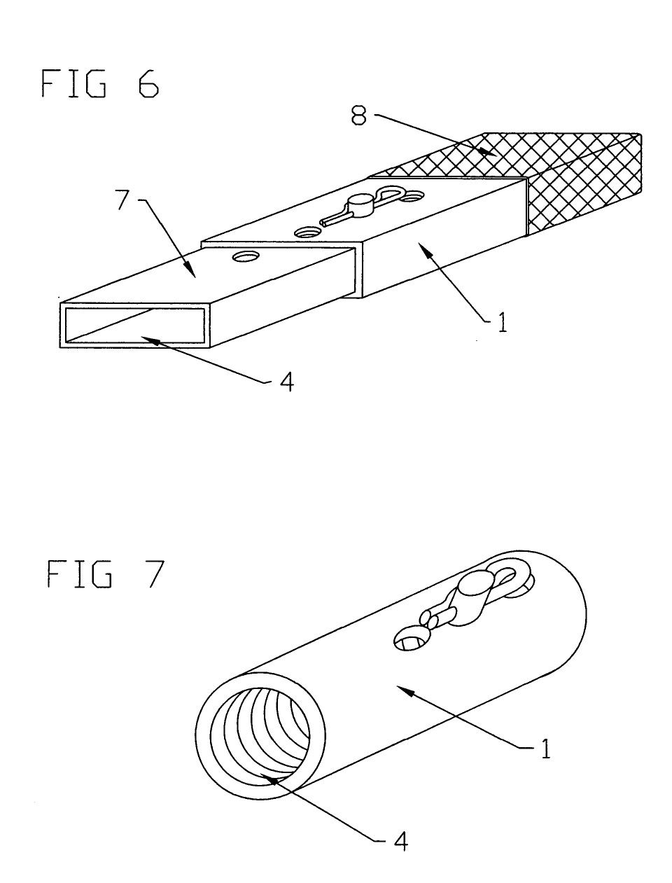

FIG. 6 shows a left-handed elevated view of blade shoe 1, having the option of an extension 7, and also a protective coating 8 on end of blade shoe 1 opposite the opening 4.

FIG. 7 shows a round blade shoe 1 and 4 showing it is also hollow.

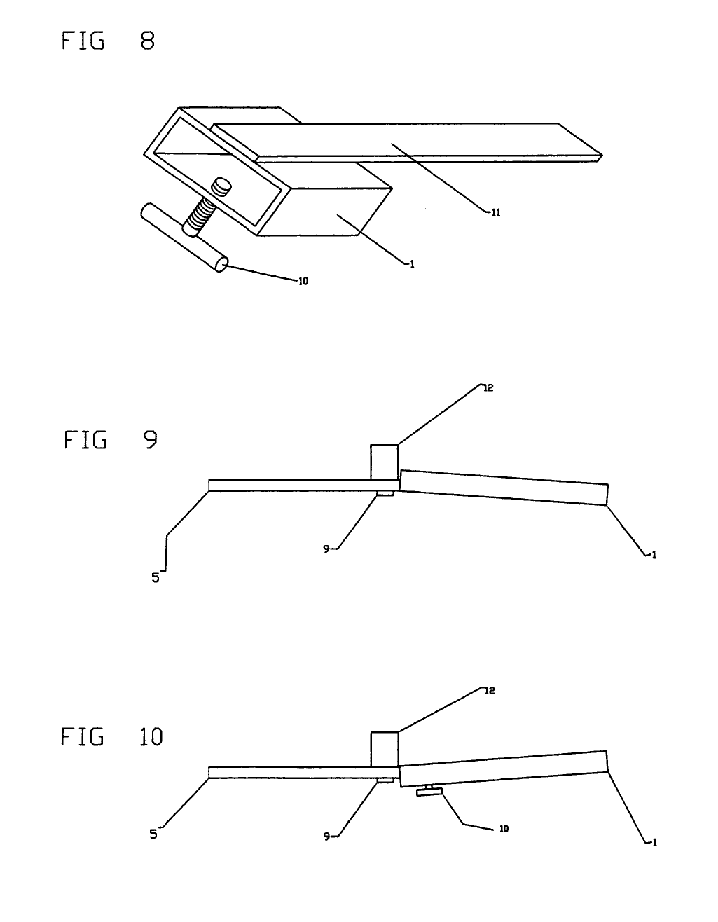

FIG. 8 shows a short blade shoe 1 with a solid extension 11.

FIG. 9. shows a blade shoe 1 without a leveler or retainer 10 over or upon a lawn mower blade 5 against the mower blade hub assembly 12.

FIG. 10 shows a blade shoe 1 with a leveler or retainer 10 over a upon a lawn mower blade 5 against the mower blade hub assembly 12.

### DRAWINGS—REFERENCE NUMERALS

1 body of blade shoe

2 adjuster for blade depth

3 blade adjuster retaining pin

4 inside of blade shoe (hollow)

5 lawn mower blade

6 lawn mower deck

7 extension for blade shoe (tubing)

8 protective coating or casing

9 lawn mower blade retaining bolt

10 blade shoe leveler and or retainer

11 attached extension for blade shoe (not tubing)

12 lawn mower blade hub assembly

### DETAILED DESCRIPTION

This device is constructed of steel or composite (strong as steel) tubular material as shown in (FIGS. 1, 7, 8). The tubing may have holes drilled or molded completely through said tubing to allow a pin or shaft 2 (FIG. 1) to be inserted through the tubing allowing it to serve as a depth gauge. This will permit long blades 5 to be inserted into said tubing and stop at the desired depth as to stop rotation of mower blade 5 against the undersides or discharge of mower deck 6 (FIGS. 2, 4, 5). At least one end of the tubing must remain open 4 (FIGS. 1, 6, 7) to allow the device to be placed over or upon mower blade 5 (FIGS. 2, 3, 5, 9, 10). This end is best suited for a leveling or retaining pin or shaft 10 (FIG. 1) allowing the device to strike mower deck 6 (FIGS. 2, 3, 4) and not drop the opposite end below the horizontal plane of blade 5 thus making a secure stop. The tubing is typically made of 1/16″ thick steel about 12 inches long (FIGS. 1, 6, 7, 8), but is not limited to this material. Steel seems to be the best suited material because it is abundant and economical. Rectangular tubing 3″×1.5″ (FIG. 1) is best suited for all blades 5 that have been produced for single and multi blade decks. Round tubing could be used, but it must be 3″ in diameter to accommodate the same blades as the 3″×1.5″ rectangular tubing. The round tubing makes it harder to produce and tends to turn allowing the pin or shaft to not function as well as rectangular 1 (FIG. 1).

For extremely long blades 5 an extension 7 (FIG. 6) can be added. For short blades 5 a shorter tubing (6″) can be used ideally with an extension 11 (FIG. 8) welded or bolted to said blade shoe 1 (FIG. 8).

The device can be manufactured of any tubing so far as it is strong enough to withstand the repeated torque or air wrenches and cheater bars and be in some way long enough to extend from the blade hub assembly 12 and reach through the outlet or the undersides of a mower deck 6 (FIGS. 2, 3, 4, 5) acting as an extension of mower blade as to stop it's rotation against the mower deck. This device works safer with a leveler and/or retainer 5 (FIGS. 1, 10) then it does with said leveler and/or retainer as the device 1 (FIG. 9).

The opposite end of the device which strikes the underside or discharge of deck could and should have a non-metallic coating 8 (FIG. 6) to assist in reducing steel splintering of the device or mower deck and also help inhibit sparks.

Operation

The manner of using this device is to first follow manufacturer recommendations (remove spark plug wire and empty gas tank) before trying to remove the mower blade 5. Next, if this is a single blade mower, manufacturer recommends turning mower over or on it's side. At this point, the device 1 would be placed over or upon mower blade 5 by sliding it over said blade at the discharge outlet allowing it to extend through said outlet by means of the device inlet 4 (FIGS. 1, 6, 7). If the recommended blade shoe (FIG. 1) is used, the leveler and/or retainer 5 (FIGS. 1, 10) is now tightened to raise the blade shoe 1 and secure it from dropping underneath the deck 6 outlet or sides. Now the retainer 9 (FIGS. 2, 3, 4) can be loosened by first rotating it until the device is solidly against mower deck 6. At this time as much torque as needed may be safely applied to loosen said retainer 9.

If the device has an adjustable depth gauge, it is placed over or upon blade 5 as to extend beyond deck 6 discharge or wedge against the sides of a multiple blade deck 6 (FIGS. 2, 3). The best location for the blade depth adjuster can be located and installed by use of the adjuster retaining pin 3 (FIG. 1). Once secure, the same steps as a single deck mower apply. Tighten the leveler and/or retainer if applicable and allow the device 1 and blade 5 to rotate slowly and strike the outlet or undersides of mower deck 6. Once contact has been made, necessary torque may be applied to safely remove said blade 5.

To install, simply turn said blade 5 and attached blade shoe 1 the opposite direction as was in taking it off. Allow device to again rotate slowly and strike mower deck 6 securely. Now the recommended torque may be applied to retainer 9. Now simply allow the device 1 and blade 6 to slowly rotate away from mower deck or discharge and if applicable loosen the leveler and/or retainer thus allowing the device 1 to be removed from blade 5.

We claim:

1. A tubular device that is positioned longitudinally over or upon the cutting blade of a rotary mower extending through the side of a lawn mower deck outlet, allowing it's side to strike either side of a rotary mower deck outlet or underneath, thus stopping the rotation of said blade.

2. The device in claim one that has an apparatus for the purpose of leveling and retaining the device to the blade of a rotary mower.

3. The device in claims one and two that is coated with or constructed of a material as to allow the device to strike a mower deck at the outlet or underneath and act as a spark or splinter inhibitor.
